(19) United States
(12) Patent Application Publication
(10) Pub. No.: US 2012/0161547 A1
(43) Pub. Date: Jun. 28, 2012

(54) USB AC Adapter With Automatic Built-In Power Switch

(75) Inventor: Arthur L. Serrano, West Hills, CA (US)

(73) Assignee: EVER WIN INTERNATIONAL CORPORATION, City of Industry, CA (US)

(21) Appl. No.: 12/979,221

(22) Filed: Dec. 27, 2010

(51) Int. Cl. H02J 7/00

(52) U.S. Cl. 307/125

(57) ABSTRACT

The USB AC adapter with automatic built in power switch comprises of an AC power supply circuit, an AC control circuit, a monitoring circuit, and a circuit for the light emitting diode indicator. The monitoring circuit further comprises of a standby power supply circuit, a microcontroller circuit, a circuit for USB chassis detector, a USB data monitor circuit, and a current monitor circuit. The AC power supply circuit is electrically connected to the alternating current source and converts the alternating current to direct current for charging the rechargeable battery of an electronic device. The AC control circuit acts as a switch to turn the AC power supply on and off. The monitor circuit detects whether an electronic device is connected to the adapter and also whether the charging process is completed. The light emitting diode indicator is used to indicate the power and charging status of the adapter.

### BACKGROUND-FIELD OF INVENTION

The present invention relates generally to alternating current adapters. More specifically, the present invention relates to an electrical adapter that converts alternating current to direct current and outputs through a universal serial bus to charge an electronic device.

### BACKGROUND-DESCRIPTION OF RELATED ART

Most modern electronic devices consume substantial amount of electrical energy to perform its complex and multiple functions. The electrical energy is generally provided by a battery enclosed within the electronic device. The battery may be a disposable battery but more commonly, it is a rechargeable battery. The rechargeable battery must be recharged with a direct current source when it is depleted.

Adapters are commonly used to convert household 110V alternating current to direct current to power and recharge electronic devices. The rechargeable battery in an electronic device is recharged by electrically connecting it to the direct current output of the adapter. The adapters are often left connected to the alternating current source even when it is not being used to recharge a rechargeable battery. Although the adapter is not being used to recharge a rechargeable battery, it nevertheless still consumes electrical power while being connected to the alternating current source. The user must either manually unplug the adapter from the alternating current source or activate a manual switch to completely shut off the consumption of electrical power by the adapter.

Additionally, when the electronic device has finished charging its rechargeable battery, yet remains connected to the adapter, the adapter continues to attempt to charge the electronic device and consuming electrical power.

Therefore, there exists an unfulfilled need to be able to conveniently eliminate this constant waste of electrical power by the adapter. A convenient means, particularly one that functions automatically without requiring any manual intervention from the user, is lacking to easily conserve the electrical power that is being wasted by the adapter.

### BRIEF SUMMARY OF THE INVENTION

The present invention is a convenient and automatic means to automatically and completely shut off the electrical power consumption by an alternating current (AC) to direct current (DC) adapter when it is not being used to recharge an electronic device. The USB AC adapter with automatic built in power switch may remain plugged into an alternating current source yet consumes no power when no electronic device is connected to it or when the electronic device that is connected to it has finished charging.

The USB AC adapter with automatic built in power switch comprises of an AC power supply circuit, an AC control circuit, a monitoring circuit, and a circuit for the light emitting diode indicator. The monitoring circuit further comprises of a standby power supply circuit, a microcontroller circuit, a circuit for USB chassis detector, a USB data monitor circuit, and a current monitor circuit. The AC power supply circuit is electrically connected to the alternating current source and converts the alternating current to direct current for charging the rechargeable battery of an electronic device. The AC control circuit, a solid state relay, acts as a switch to turn the AC power supply on and off. The monitor circuit detects whether an electronic device is connected to the adapter and also whether the charging process is completed. The light emitting diode indicator is used to indicate the power and charging status of the adapter.

### BRIEF DESCRIPTION OF THE DRAWINGS

FIG. 1 shows the complete schematic of the preferred embodiment of the USB AC adapter with automatic built in power switch.

FIG. 2 shows the 5 W AC power supply circuit.

FIG. 3 shows the AC control circuit.

FIG. 4 shows the standby power supply circuit.

FIG. 5 shows the microcontroller circuit.

FIG. 6 shows the circuit for USB chassis detector.

FIG. 7 shows the USB data monitor circuit.

FIG. 8 shows the current monitor circuit.

FIG. 9 shows the circuit for the light emitting diode indicator.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

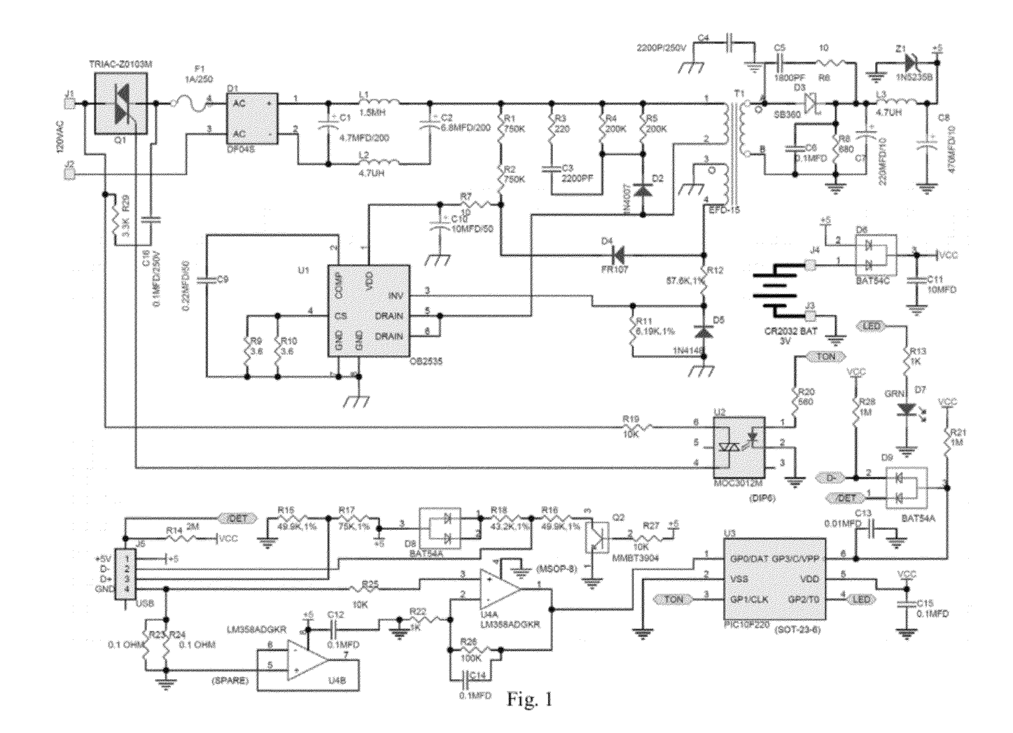

FIG. 1 shows the complete schematic of the preferred embodiment of the USB AC adapter with automatic built in power switch. The USB AC adapter with automatic built in power switch comprises of an alternating current (AC) power supply circuit, an AC control circuit, a monitoring circuit, and a circuit for the light emitting diode indicator. The monitoring circuit further comprises of a standby power supply circuit, a microcontroller circuit, a circuit for USB chassis detector, a USB data monitor circuit, and a current monitor circuit.

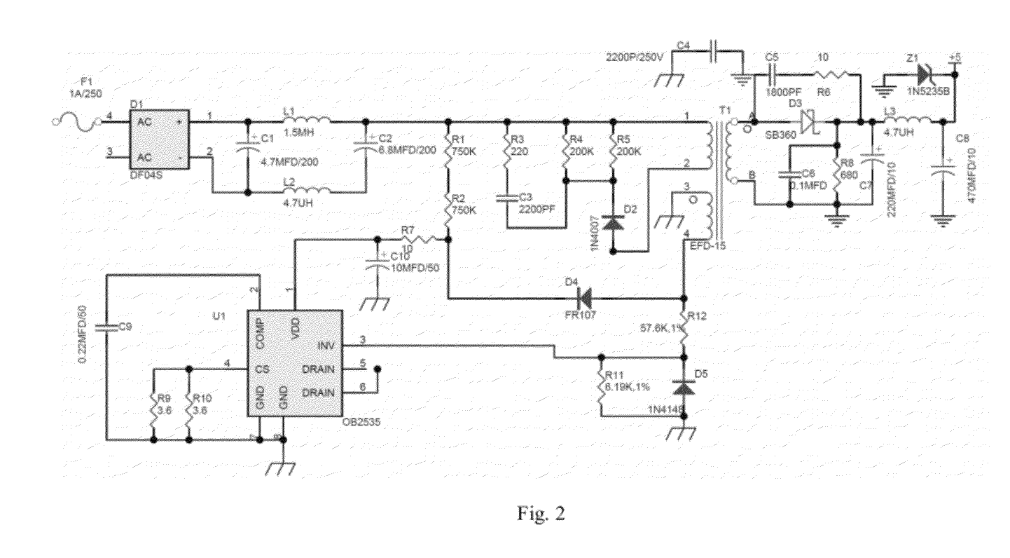

FIG. 2 shows the AC power supply circuit. The preferred embodiment of the present invention uses a 5 W AC power supply circuit. This AC power supply circuit design is well known in the art. It electrically connects to an AC power source and outputs 5V direct current (DC) and can supply 1A. FIG. 2 represents a 5 W example and can be replaced by any other similar 5, 10, or 20 W AC power supply circuit design well known in the art.

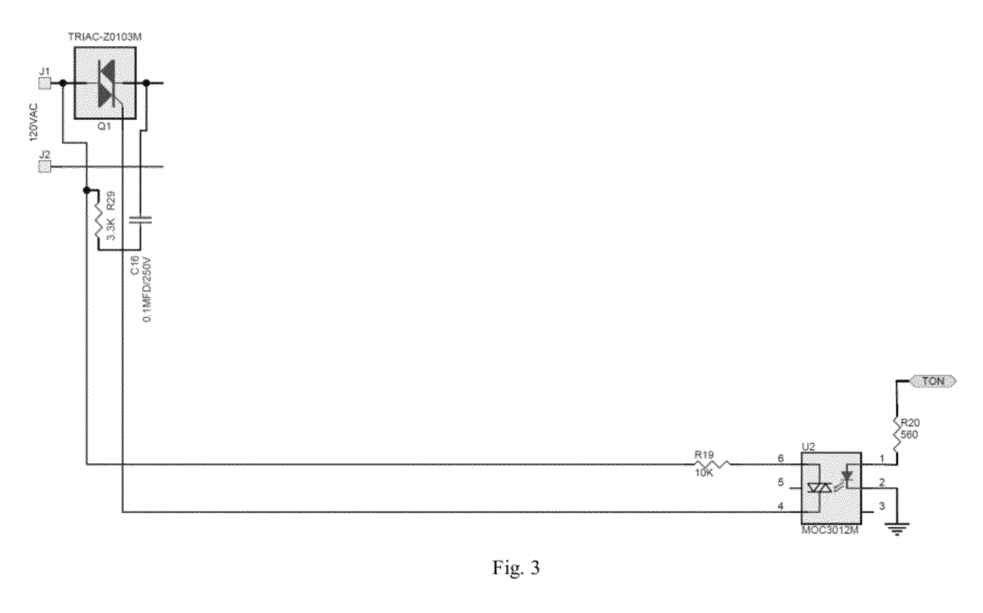

FIG. 3 shows the control circuit on the AC side of power supply. This function is generally referred to as a “solid state relay.” It comprises a high sensitivity TRIAC (Q1) placed in series with the 120V AC input. This acts as a switch between the one side of the AC line and the power supply circuit. The other side of the 120V AC line is directly connected to the power supply. The TRIAC is turned on by an optically isolated TRIAC driver U2. Underwriters Laboratories Inc. (UL) regulations dictate that in an AC power supply adapter there must be isolation between the high voltage 120V AC side and the low voltage DC side that the user comes in contact with. U2 is controlled by a logic signal (TON) from the microcontroller. When TON is low (0V), U2 is turned off which causes the TRIAC switch to open up, turning off the AC power supply completely. When TON is high (+3V to +5V) U2 is turned on causing the TRIAC switch to close, applying power to the AC power supply circuit.

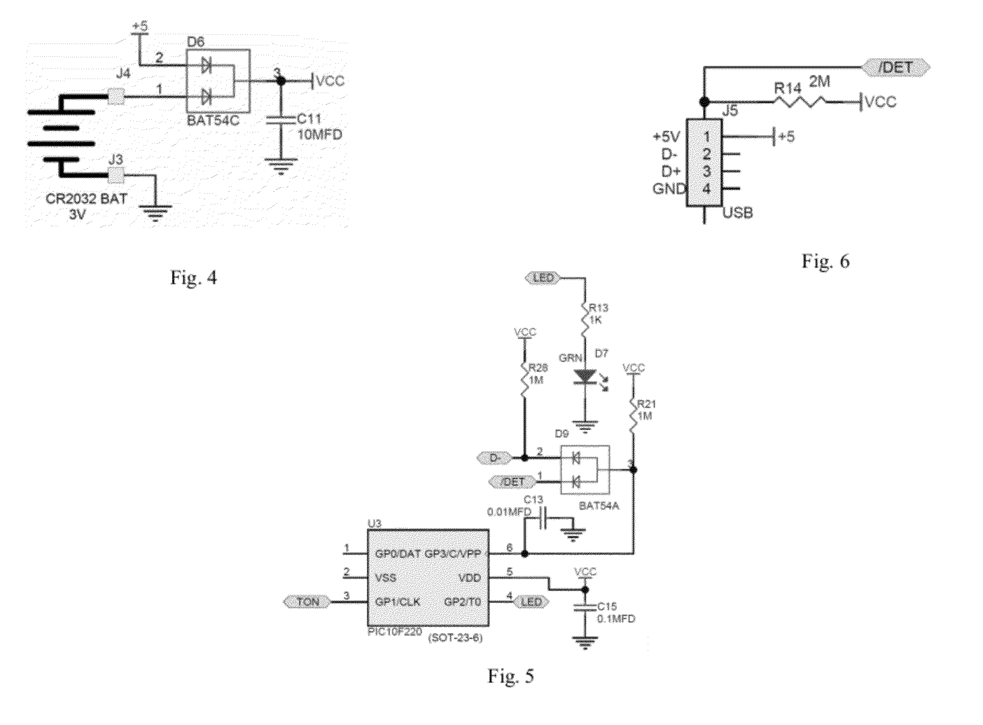

FIG. 4 shows the standby power supply portion of the monitor circuit. Power to the microcontroller/monitor circuit is preferably provided by a 3V lithium coin cell battery when the power supply is turned off. However, any other suitable battery may be used. The standby power drain from this battery while the AC is off is approximately 100 nanoamps. Once the AC power is turned on and the AC supply outputs 5V, the power to the monitor/microcontroller (VCC) is provided by the 5V supply and not the battery. Section 1 of the dual diode D6 is reversed biased when the 5V is conducting through section 2, thus blocking current from the coin cell battery. This will minimize the use of the power from the coin cell battery and extend the useful life of the coin cell battery.

FIG. 5 shows the microcontroller portion of the monitor circuit. A very simple microcontroller (MCU) is used in the preferred embodiment. U3 is a Microchip PIC10F220. Any other similar microcontroller can be used for this purpose. In the preferred embodiment, the MCU uses a double detector circuit to sense that a device is connected to the adapter to turn the AC power on. Two independent methods are used to detect the presence of an electronic device.

FIG. 6 shows the USB chassis detector portion of the monitor circuit. A wire is connected to the metal chassis of the USB detector. This chassis normally makes contact with the shield wire of a USB cable. The shield is not connected to any other contact of the USB connector and is only connected to the metal chassis at the other end of the USB cable.

In the typical wiring of a USB to device cable, the metal frame (chassis) is connected to the cable shield but not to any other signal wire. When a device is connected to the cable, the device connects the system ground to the frame. The USB frame connection is pulled up via resistor R14 to VCC (+3V). When a device is connected to the USB cable, the /DET signal is pulled low (0V).

/DET is connected to a dual diode D9 which is used as logic OR circuit. That is, either /DET or D− going low will make U3 pin 3 go low, waking up the MCU from a deep sleep mode. When the MCU wakes up, it sets the TON signal (pin 3) high. This causes the U2 to turn the TRIAC on as explained before and the AC supply to power up. VCC rises from 3V to 5V. The coin cell battery provides less than 2 milliamps to turn on the TRIAC circuit, and only for a period of 20 msec to 2 seconds depending on the response time of the AC power supply. After the AC supply turns on, the power to keep the TRIAC on is provided by the 5V supply and not by the coin cell battery.

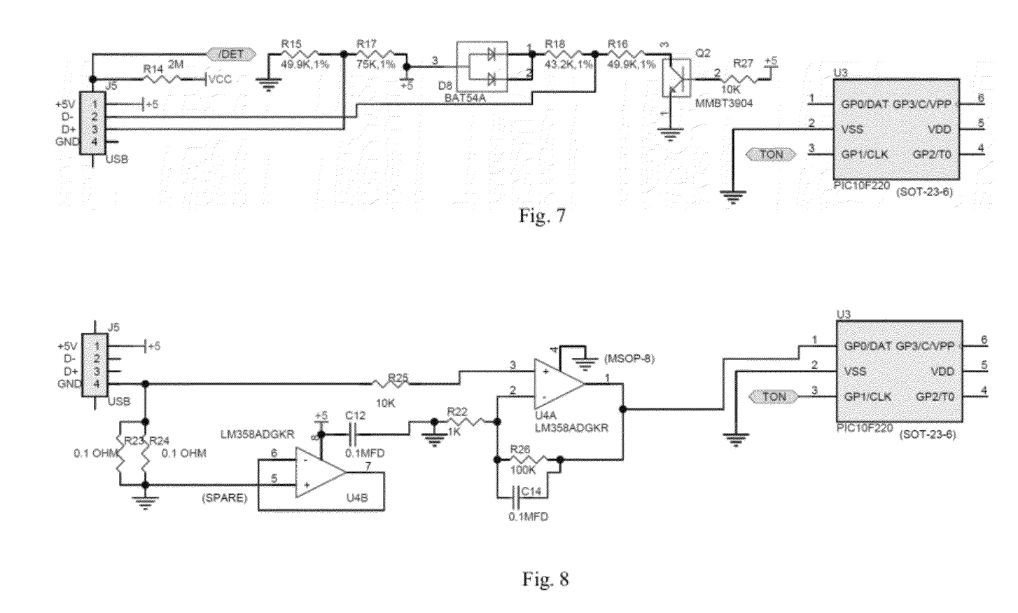

FIG. 7 shows the USB data monitor circuit. If a USB cable used with the present invention does not have a shield wire connected between the two frames, then the present invention can detect the presence of a device by monitoring one or both of the USB data lines. In one embodiment, the D− (USB pin 2) data line is used. In a normal USB power supply for Apple iPods for example, D− is connected to a resistor network as specified in the Apple iPod specification. In this embodiment resistors R18 and R16, which form the aforementioned network, are disabled by D8 and Q2 when the power supply is off. D8 is reverse biased to prevent leakage via the rest of the components connected to +5V. Since the 5V supply is off, Q2 base is biased low and transistor Q2 is turned off. This removes the ground return from the resistor network. D− is also pulled up to VCC by the 1M resistor (R28). When a device is connected, D− is pulled low by the load of the device. This causes the MCU pin 6 to go low via the D9 diode. The MCU then sets TON high and supply turns on. Once 5V is present, D8 is forward biased, Q2 is turned on, and the resistor network connected to D− returns to the normal state.

Alternatively, the D+ data line can also be used for this purpose.

Further, both lines with duplicate circuits can be used in an either/or fashion. The MCU can be awaken by either the USB frame being grounded or a data line being loaded to ground.

FIG. 8 shows the current monitor circuit. Before the power supply turns on, 5V will be off and U4 OPAMP will be powered off and will not draw any current from the coin cell battery due to the reverse bias of D6 section 1. Once the power supply is turned on and 5V is present, OPAMP (U4) is powered up. Current drawn by the device is measured as a voltage drop across R23 and R24. This voltage signal is amplified by U4A non-inverting amplifier and presented to the analog to digital converter (A/D) function of the MCU (U3 pin 1). If the current drawn from the 5V supply by the charging device falls below a predetermined threshold (e.g. 90 milliamps), for a predetermined time (e.g. 20 seconds), the MCU will set TON signal low, causing the AC power to turn off. Also, if the device is disconnected, the power will turn off after the timer expires.

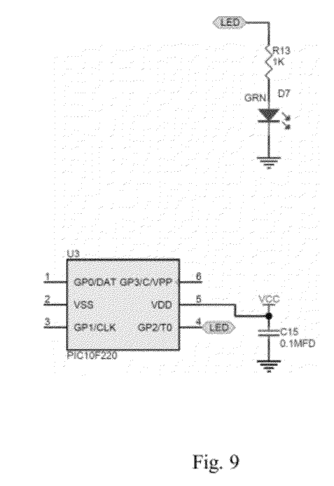

FIG. 9 shows the circuit for the light emitting diode (LED) indicator. When the AC power is turned off, the LED indicator D7 will be turned off. When the supply is on, the MCU can drive the LED using a pulse width modulated signal (PWM). This will cause the brightness of the LED to change with time in a cyclic manner (glowing brighter and darker). This glowing cycle can be tied to the amount of current being drawn by the device. For example, as the device draws greater current, the LED can glow on and off at a faster rate. As the charge current decreases, the glowing rate can also decrease. When the current nears the predetermined threshold (e.g. 90 mA) the glow rate will stop. When the charge current falls below the predetermined threshold, the supply will go off and the LED will go off.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A USB AC adapter with automatic built in power switch comprising:
an AC power supply circuit,
an AC control circuit to switch the AC power supply circuit on and off, and
a monitoring circuit to monitor the connection of the adapter to the power supply and to a device.

2. A USB AC adapter with automatic built in power switch as in claim 1 further comprising a circuit for a light emitting diode indicator to indicate the power and charging status of the adapter.

3. A USB AC adapter with automatic built in power switch as in claim 2 wherein said circuit for a light emitting diode indicator glows cyclically to indicate charging status.

4. A USB AC adapter with automatic built in power switch as in claim 1 wherein said monitoring circuit further comprises:
a standby power supply circuit to provide power to the monitor circuit when the AC power supply is off,
a microcontroller circuit,
a circuit for USB chassis detector,
a USB data monitor circuit, and
a current monitor circuit.

5. A USB AC adapter with automatic built in power switch as in claim 4 wherein said standby power supply circuit is powered by a coin cell battery.

6. A USB AC adapter with automatic built in power switch as in claim 4 wherein said USB data monitor circuit monitors one USB data line.

7. A USB AC adapter with automatic built in power switch as in claim 4 wherein said USB data monitor circuit monitors more than one USB data line.

8. A USB AC adapter with automatic built in power switch comprising:
an AC power supply circuit,
an AC control circuit to switch the AC power supply circuit on and off,
a monitoring circuit to monitor the connection of the adapter to the power supply and to a device, and
a circuit for a light emitting diode indicator to indicate the power and charging status of the adapter.

9. A USB AC adapter with automatic built in power switch as in claim 8 wherein said circuit for a light emitting diode indicator glows cyclically to indicate charging status.

10. A USB AC adapter with automatic built in power switch as in claim 8 wherein said monitoring circuit further comprises:
a standby power supply circuit to provide power to the monitor circuit when the AC power supply is off,
a microcontroller circuit,
a circuit for USB chassis detector,
a USB data monitor circuit, and
a current monitor circuit.

11. A USB AC adapter with automatic built in power switch as in claim 10 wherein said standby power supply circuit is powered by a coin cell battery.

12. A USB AC adapter with automatic built in power switch as in claim 10 wherein said USB data monitor circuit monitors one USB data line.

13. A USB AC adapter with automatic built in power switch as in claim 10 wherein said USB data monitor circuit monitors more than one USB data line.

14. A USB AC adapter with automatic built in power switch comprising:
an AC power supply means,
an AC control circuit means switch the AC power supply means on and off, and
a monitoring means to monitor the connection of the adapter to the power supply and to a device.

15. A USB AC adapter with automatic built in power switch as in claim 14 further comprising a means to indicate the power and charging status of the adapter.

16. A USB AC adapter with automatic built in power switch as in claim 14 wherein said monitoring means further comprises:
a standby power supply means to provide power to the monitoring means when the AC power supply is off,
a microcontroller,
a USB chassis detector means,
a USB data monitor means, and
a current monitor means.

17. A USB AC adapter with automatic built in power switch as in claim 16 wherein said standby power supply means is powered by a coin cell battery.

18. A USB AC adapter with automatic built in power switch as in claim 16 wherein said USB data monitor means monitors one USB data line.

19. A USB AC adapter with automatic built in power switch as in claim 16 wherein said USB data monitor means monitors more than one USB data line.
